(19) United States
(12) Patent Application Publication
(10) Pub. No.: US 2017/0174856 A1
(43) Pub. Date: Jun. 22, 2017

(54) THERMOPLASTIC POLYMER FOAMING SOLE AND METHOD FOR MANUFACTURING THERMOPLASTIC POLYMER FOAMING SOLE

(71) Applicant: POU CHEN CORPORATION, Changhua County (TW)

(72) Inventors: Nai-Chiang TSAI, Changhua County (TW); Sheng-Jung HSIAO, Changhua County (TW); Chao-Ping YANG, Changhua County (TW)

(21) Appl. No.: 15/373,484

(22) Filed: Dec. 9, 2016

(30) Foreign Application Priority Data
Dec. 16, 2015 (TW) 104142320

(51) Int. Cl. C08J 9/12; B29C 44/12; B29D 35/12; B29B 11/14

(52) U.S. Cl. CPC C08J 9/122; B29B 11/14; B29C 44/12; B29D 35/122; C08J 2203/06; C08J 2375/04; C08J 2367/00; B29K 2075/00

(57) ABSTRACT

A method for manufacturing a thermoplastic polymer foaming sole includes the following steps. A prototype is formed. The prototype includes thermoplastic polyurethane or thermoplastic polyester elastomer but excludes a cross-linking agent and a foaming agent, and the prototype is sole-shaped. A supercritical fluid is used to foam the prototype so as to directly get the thermoplastic polymer foaming sole. A density of the thermoplastic polymer foaming sole is larger than or equal to 0.3 g/cm³ and smaller than or equal to 0.8 g/cm³.

### RELATED APPLICATIONS

This application claims priority to Taiwan Application Serial Number 104142320, filed Dec. 16, 2015, which is herein incorporated by reference.

### BACKGROUND

### Technical Field

The present disclosure relates to a foaming sole and a method for manufacturing a foaming sole. More particularly, the present disclosure relates to a method for manufacturing a foaming sole with thermoplastic polyurethane or thermoplastic polyester elastomer and a thermoplastic polymer foaming sole made by the method.

### Description of Related Art

Rubber is a conventional sole material for shoes. Because the density of the rubber sole is larger than 1.2 g/cm³, huge amount of rubber must be used to increase the vibration absorbing ability of shoes. As a result, the, weight of the shoes is increased. Hence, this kind of shoes is not suitable for sneakers which has a demand of light characteristic. Therefore, rubber sole has its limitation.

In order to fit the light demand of sneakers, some practitioners developed a foaming sole which is made by foaming an ethylene-vinyl acetate (hereinafter refer to as “EVA”) material. The sole made by foaming EVA material not only has good vibration absorbing ability but also has characteristics of softness, comfort, and lightness. Consequently, the sole made of EVA is applied to sneakers as well as casual shoes.

However, chemicals, such as foaming agents, cross inking agents, or chemicals with other effects, will be added according to manufacturing needs in EVA foaming process. Not only will the addition of these chemicals affect the health of the operators, but the evaporated chemicals will also increase the loading of the natural environment. In addition, residues of the above mentioned chemicals remain on the foamed'EVA, and more processes are necessary for removing the residues.

In order to reduce the influence to the natural environment and the residues of the chemicals, chemical foaming method is replaced by physical foaming method. For example, foamed particles are produced by using supercritical fluid as the foaming agent, and soles are then made by the foamed particles through hot pressing process or other processes so as to obtain products with proper sizes and types. The producing method is very complex.

Therefore, how to simplify the process and to produce foamed shoes with different density to fit different demands become a pursue target for the practitioners.

### SUMMARY

According to one aspect of the present disclosure, a method for manufacturing a thermoplastic polymer foaming sole is provided. The method includes the following steps. A prototype is formed. The prototype includes thermoplastic polyurethane or thermoplastic polyester elastomer but excludes a cross-linking agent and a foaming agent, and the prototype is sole-shaped. A supercritical fluid is used to foam the prototype so as to directly get the thermoplastic polymer foaming sole. A density of the thermoplastic polymer foaming sole is larger than or equal to 0.3 g/cm³ and smaller than or equal to 0.8 g/cm³.

According to another aspect of the present disclosure, a method for manufacturing a thermoplastic polymer foaming sole is provided. The method includes the following steps. A liquid base material is formed, which includes thermoplastic polyurethane or thermoplastic polyester elastomer. The liquid base material is formed into a prototype by infusing the liquid base material into a shaping mold. The prototype is disposed in a foaming mold. A supercritical fluid is introduced in the foaming mold to allow the supercritical fluid to penetrate into the prototype. The foaming mold is depressurized to allow the prototype to foam into the thermoplastic polymer foaming sole. A density of the thermoplastic polymer foaming sole is larger than or equal to 0.3 g/cm³ and smaller than or equal to 0.8 g/cm³.

### BRIEF DESCRIPTION OF THE DRAWINGS

The disclosure can be more fully understood by reading the following detailed description of the embodiments, with reference made to the accompanying drawings as follows:

FIG. 1 is a flow chart of a method for manufacturing a thermoplastic polymer foaming sole according to one embodiment of the present disclosure;

FIG. 2A to FIG. 2C are schematic diagrams showing detailed manufacturing steps of the method of FIG. 1;

FIG. 3 is a flow chart of a method for manufacturing a thermoplastic polymer foaming sole according to another embodiment of the present disclosure;

FIG. 4A to FIG. 4E are schematic diagrams showing detailed manufacturing steps of the method of FIG. 3; and

FIG. 5 is a schematic view showing a thermoplastic polymer foaming midsole applied to a shoe according to further embodiment of the present disclosure.

### DETAILED DESCRIPTION

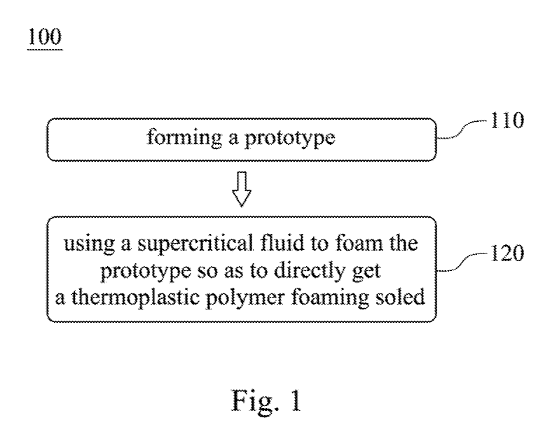

Please refer to FIG. 1, FIG. 1 is a flow chart of a method 100 for manufacturing a thermoplastic polymer foaming sole according to one embodiment of the present disclosure. The method 100 includes Step 110 and Step 120.

in Step 110, a prototype is formed. The prototype includes thermoplastic polyurethane or thermoplastic polyester elastomer but, excludes a cross-linking agent and a foaming agent, and the prototype is sole-shaped.

In Step 120, a supercritical fluid is used to foam the prototype so as to directly get the thermoplastic polymer foaming sole.

A density of the thermoplastic polymer foaming sole is larger than or equal to 0.3 g/cm³ and smaller than or equal to 0.8 g/cm³.

Therefore, the size and the type of the thermoplastic polymer foaming sole can fit the requirement of the expected product because t he prototype foamed by the supercritical fluid can achieve a predetermined size. As a result, the thermoplastic polymer foaming sole can directly applied to a shoe and goals of process simplification, cycle time reduction and cost reduction can be achieved. Moreover, if the density of the thermoplastic polymer foaming sole is larger than or equal to 0.3 g/cm³ and smaller than or equal to 0.8 g/cm³, the manufacturing yield is better and the cycle time is shorter. A detailed process of an embodiment will be describe below.

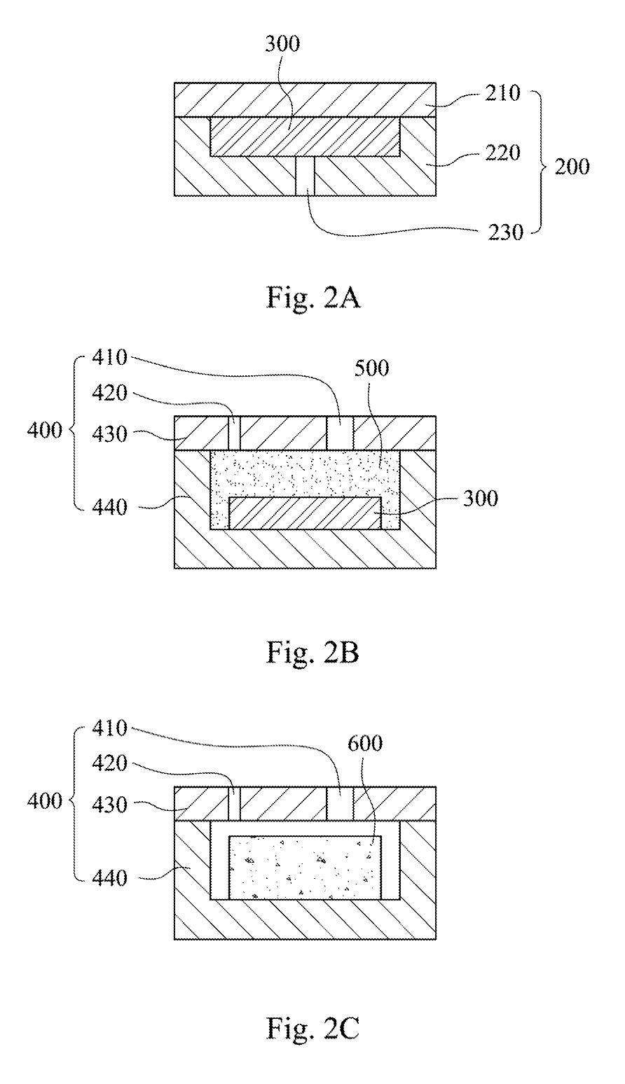

Please refer to FIGS. 2A to 2C. FIGS. 2A to 2C are schematic diagrams showing detailed manufacturing steps of the method 100 of FIG. 1.

As shown in FIG. 2A, a shaping mold 200 includes a shaping up per cover 210, a shaping lower cover 220 and an inlet 230. The shaping upper cover 210 is covered on the shaping lower cover 220 to form an infusing space (not labeled). The inlet 230 is disposed at the shaping lower cover 220 and communicated with the infusing space. During manufacturing, a liquid base material (not shown) is, infused into the infusing space via the inlet 230, and the liquid base material is then cooled down to room temperature to form the prototype 300. In this embodiment, the liquid base material includes thermoplastic polyurethane but excludes the cross-linking agent and the foaming agent. In another embodiment, the liquid base material includes thermoplastic polyester elastomer but excludes the cross-linking agent and the foaming agent. In further another embodiment, the liquid base material is consist of thermoplastic polyurethane or thermoplastic polyester elastomer.

An inner side of the shaping upper cover 210, which face toward the infusing space and an inner side of the shaping lower cover 220, which face toward the infusing space, both have special surface (not shown) to allow the prototype 300 to be shaped as a sole which expected to be made. A largest thickness of the prototype 300 is about 4 mm in the embodiment but is larger than or equal to 2 mm and smaller than or equal to 8 mm in other embodiment.

As shown is FIG. 2B, the prototype 300 is disposed into a foaming mold 400 to prepare for foaming. The foaming mold 400 includes a foaming upper cover 430, a foaming lower cover 440, a fluid inlet 420 and an outlet 410. The foaming upper cover 430 is covered on the foaming lower cover 440 to form a foaming space (not labeled). The fluid inlet 420 and the outlet 410 is disposed on the foaming upper cover 430 and is communicated with the foaming space. During manufacturing, the supercritical fluid 500 is infused into the foaming space via the fluid inlet 420. A temperature and a pressure of the foaming mold 400 is maintained in order to allow the supercritical fluid 500 to penetrate into the prototype 300. The value of the temperature and the pressure of the foaming mold 400 can be changed according to different kind of supercritical fluid 500, which should be larger enough to keep the supercritical fluid 500 in supercritical fluid state.

As shown in FIG. 2C, the outlet 410 is opened to release the pressure after a period of time. The supercritical fluid 500 gasifies due to decline of the pressure, and the supercritical fluid 500 penetrated into the prototype 300 (shown in FIG. 2B) disappears after forming a plurality of gas cores inside the prototype 300; thus, the prototype 300 is foamed to form the thermoplastic polymer foaming sole 600 directly. Therefore, the thermoplastic polymer foaming sole 600 has a plurality of microporous structures owning to the effect of the supercritical fluid 500. The average diameter of each microporous is larger than 0 micrometer and smaller than 100 micrometers.

Through changing the physical status of the supercritical fluid 500 by changing the pressure, the prototype 300 can be foamed to form the thermoplastic polymer foaming sole 600 without any additions of chemicals. Hence, there is no chemical residue remained on the thermoplastic polymer foaming sole 600. Moreover, the volatilized supercritical fluid 500 is recycled via the outlet 410 and the environment pollution can be prevented.

The above mentioned term “supercritical fluid” means a substance which can be viewed as a uniform phase when the substance at a certain temperature and pressure above its critical point and the density of the gas phase and the liquid phase is the same. The property of the supercritical fluid 500 is between gas phase and liquid phase. In the embodiment, the supercritical fluid 500 is carbon oxide, but it can be, but not limited, water, methane, ethane, ethylene, propylene, methanol, ethanol, acetone or nitrogen which can penetrate into the prototype 300 and form a plurality of gas core inside the prototype 300 due to the changed of the pressure.

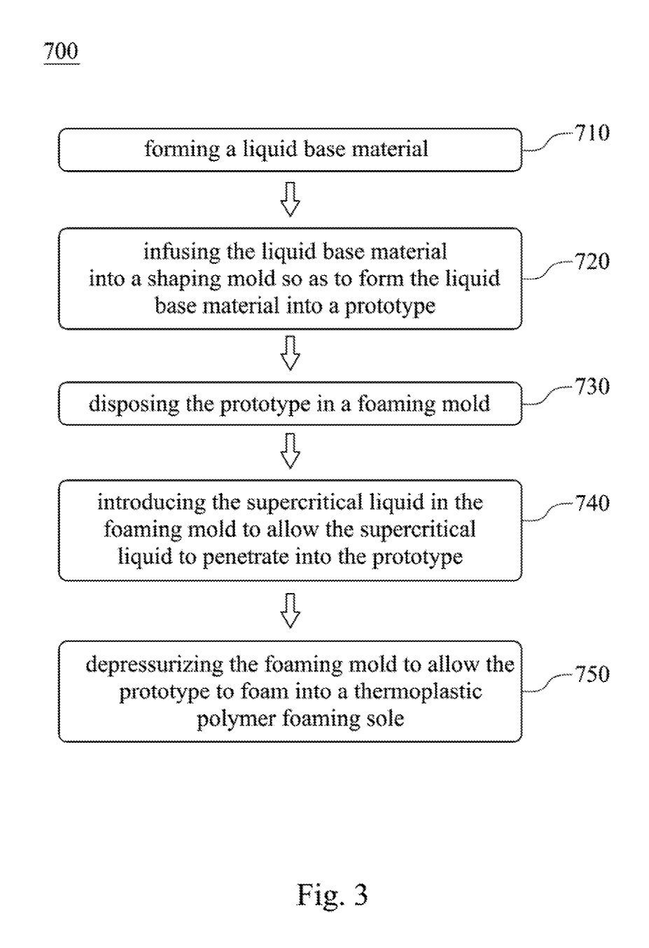

Please refer to FIG. 3. FIG. 3 is a flow chart of a method 700 for manufacturing a thermoplastic polymer foaming sole according to another embodiment of the present disclosure. The method 700 includes Steps 710 to 750.

In Step 710, a liquid base material formed, which includes thermoplastic polyurethane or thermoplastic polyester elastomer,

In Step 720, the liquid base material is formed into a prototype by infusing the liquid base material into a shaping mold.

In Step 730, the, prototype is disposed in a foaming mold.

In Step 740, the supercritical fluid is introduced in the foaming mold to allow the supercritical fluid to penetrate into the prototype.

In Step 750, the foaming mold is depressurized to allow the prototype to foam into the thermoplastic polymer foaming sole.

A density of the thermoplastic polymer foaming sole is larger than or equal to 0.3 g/cm³ and smaller than or equal to 0.8 g/cm³.

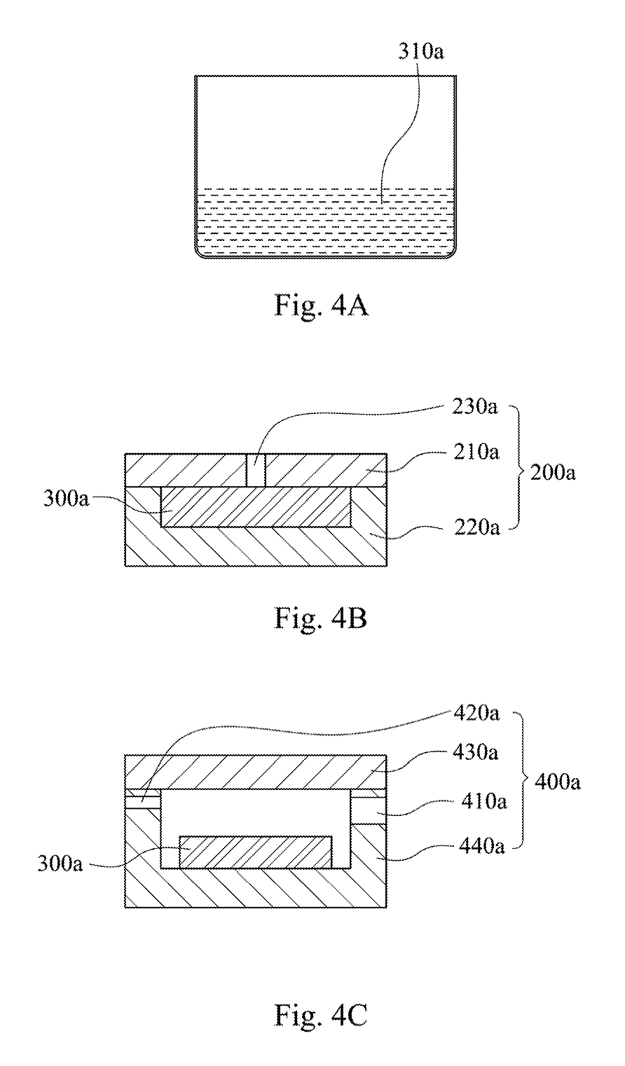

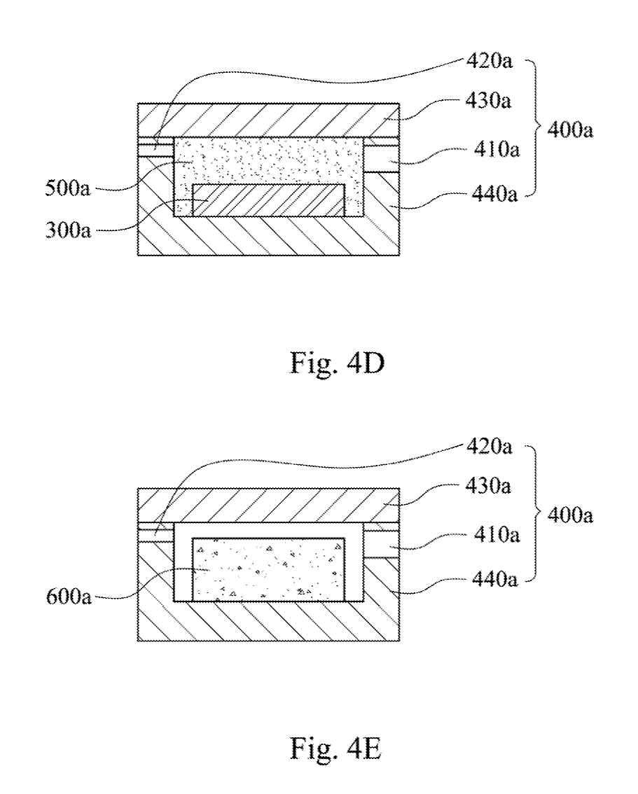

Please refer to FIGS. 4A to 4E. FIGS. 4A to 4E are schematic diagrams showing detailed manufacturing steps of the method 700 of FIG. 3.

As shown in FIG. 4A, a shaping material is heated to form the liquid base material 310a. The shaping material is consisted of thermoplastic polyurethane in the embodiment, but is consisted of thermoplastic polyester elastomer in another embodiment.

As shown in FIG. 4B, the shaping mold 200a includes a shaping upper cover 210a, a shaping lower cover 220a and an inlet 230a. The structure of the shaping mold 200a is similar to the shaping mold 200 of FIG. 2A, but the disposition of the inlet 230a is different. The liquid base material 310a is infusing into an infusing space (not labeled) of the shaping mold 200a via the inlet 230a. The prototype 300a is formed after the liquid base material 310a is cooled.

As shown in FIGS. 4C and 4D, the foaming mold 400a includes a foaming upper cover 430a, a foaming lower cover 440a, a fluid inlet 420a and an outlet 410a. The structure of the foaming mold 400a is similar to the foaming mold 400 of FIG. 28, but the dispositions of the fluid inlet 420a and the outlet 410a are different. During manufacturing, the prototype 300a is disposed into the foaming mold 400a and the supercritical fluid 500 is infused into a foaming space (not labeled) of the foaming mold 400a via the fluid inlet 420a. A temperature and a pressure of the foaming mold 400a is maintained in order to allow the supercritical fluid 500a to penetrate into the prototype 300a.

After the prototype 300a is disposed into the foaming mold 400a, the foaming mold 400a can be pre-heated to 95° C. or 180° C. first, and the supercritical fluid 500a is then infused into the foaming mold 400a. The temperature is remained the same during the process.

As shown in FIG. 4E, the outlet 410a is opened to release the pressure after a period of time, and the prototype 300a is foamed to form the thermoplastic polymer foaming sole 800a directly.

in addition, through adjusting the temperature, the pressure and the time during the process, the density of the thermoplastic polymer foaming sole 600a is larger than or equal to 0.3 g/cm³ and smaller than or equal to 0.8 g/cm³, which has larger range, and the thermoplastic polymer foaming sole 600a can be applied to different portions of shoes.

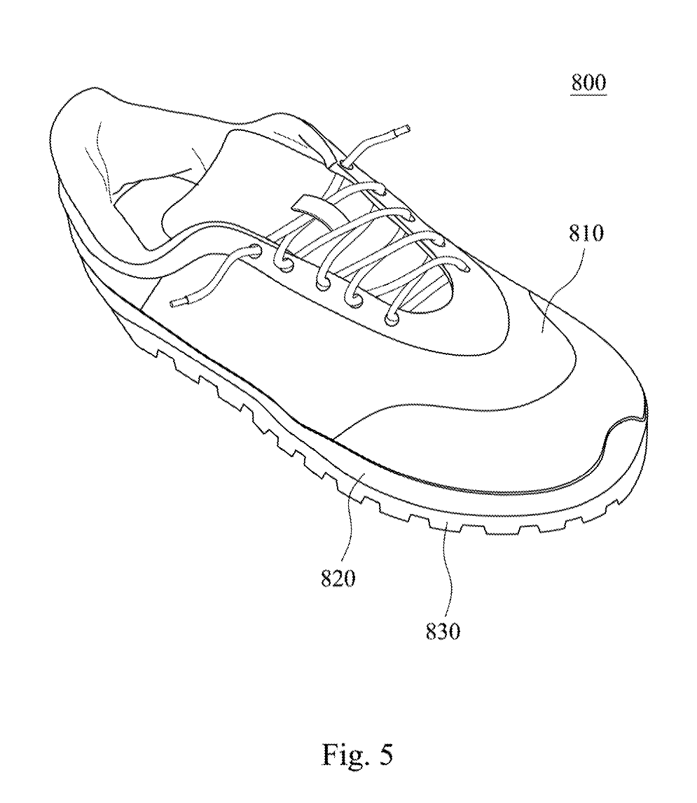

Please refer to FIG. 5, FIG. 5 is a schematic view showing a thermoplastic polymer foaming midsole 820 applied to a shoe 800 according to further embodiment of the present disclosure. The shoe 800 includes a wearing portion 810, the thermoplastic polymer foaming midsole 820, and an outsole 830. The thermoplastic polymer foaming midsole 820 is connected to the wearing portion 810 and the outsole is connected to the thermoplastic polymer foaming midsole 820. In the embodiment, the thermoplastic polymer foaming midsole 820 is made by any method mentioned above, and the density of the thermoplastic polymer foaming midsole 820 is 0.4 g/cm³, but the density of the thermoplastic polymer foaming midsole 820 can be larger than or equal to 0.3 g/cm³ and smaller than or equal to 0.45 g/cm³ in other embodiments.

Furthermore, in another embodiment, the outsole 830 can be replaced by a thermoplastic polymer foaming outsole which is made by any method mentioned above. The density of the thermoplastic polymer foaming outsole is 0.7 g/cm³, but the density of the thermoplastic polymer foaming outsole can be larger than or equal to 0.45 g/cm and smaller than or equal to 0.8 g/cm³ in other embodiments.

Please refer to Table 1 below, which shows the manufacturing parameters of examples 1 to 10. The term “process time” refers to the time difference between the time at which the supercritical fluid is infusing into the foaming mold and the time at which the foaming mold is depressurized Through controlling the pressure, the temperature and the time of the process, the density of the thermoplastic polymer foaming sole can be changed.

TABLE 1
The manufacturing parameters of each example

| | | | pressure of | Temperature | | |
|---|---|---|---|---|---|---|
| Example | | supercritical | supercritical | of foaming | process | density |
| number | material | fluid | fluid (Psi) | mold (° C.) | time(min) | (g/cm³) |
| 1 | thermoplastic | carbon | 1500 | 120 | 10 | 0.8 |
| | polyurethane | oxide | | | | |
| 2 | thermoplastic | carbon | 2000 | 125 | 15 | 0.6 |
| | polyurethane | oxide | | | | |
| 3 | thermoplastic | carbon | 2000 | 130 | 20 | 0.4 |
| | polyurethane | oxide | | | | |
| 4 | thermoplastic | carbon | 1500 | 130 | 15 | 0.8 |
| | polyester elastomer | oxide | | | | |
| 5 | thermoplastic | carbon | 2000 | 135 | 20 | 0.6 |
| | polyester elastomer | oxide | | | | |
| 6 | thermoplastic | carbon | 2000 | 140 | 25 | 0.5 |
| | polyester elastomer | oxide | | | | |
| 7 | thermoplastic | carbon | 3000 | 145 | 30 | 0.3 |
| | polyester elastomer | oxide | | | | |
| 8 | thermoplastic | nitrogen | 1500 | 120 | 20 | 0.8 |
| | polyurethane | | | | | |
| 9 | thermoplastic | nitrogen | 2000 | 125 | 40 | 0.55 |
| | polyurethane | | | | | |
| 10 | thermoplastic | nitrogen | 3000 | 130 | 60 | 0.4 |
| | polyurethane | | | | | |

It can be known from the above examples, the density of the thermoplastic polymer foaming sole can be adjusted by controlling the temperature and the pressure of the process such that the range of the density the thermoplastic polymer foaming sole made thereof is between 0.3 g/cm³ to 0.8 g/cm³ and the process time is smaller than or equal to 60 minutes. The process time does be reduced comparing to the conventional process.

As known from the above embodiment, the present disclosure includes the following advantages.

1. For conventional foaming technique, some particles are made of thermoplastic polyurethane or thermoplastic polyester elastomer. The particles are then be foamed by supercritical fluid to form a plurality of foamed particles. The foamed particles will be boned together by hot pressing process to become a sole. Hence, there is no prototype in the conventional foaming process. Through making the prototype, the process can be simplified.

2. Foaming a prototype is harder than foaming a particle because the shape and size is hardly controlled after foaming. As a result, the manufacturing yield is low. Through controlling the density of the thermoplastic polymer foaming sole in a range between 0.3 g/cm³ to 0.8 g/cm³, the shape relation between the prototype and the thermoplastic polymer foaming sole can be controlled. In addition to the reduction of the cycle time, the manufacturing yield of the thermoplastic polymer foaming sole can be increased as well.

The diffusing rate of the supercritical fluid and the infusion rate of the supercritical fluid inside the prototype is relative to the pressure, the temperature and the process time; therefore, the pressure, the temperature and the process time of the supercritical fluid in the process can be chosen according to the different foaming ratio. When the pressure of the supercritical fluid is larger than or equal to 1000 psi and smaller than or equal to 3000 psi, the foaming yield is better if the temperature of the foaming is a so larger than or equal to 95° C. and smaller than or equal to 180° C.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims,

What is claimed is:

1. A method for manufacturing a thermoplastic polymer foaming sole, comprising.
(a) forming a prototype, the prototype comprising thermoplastic polyurethane or thermoplastic polyester elastomer but excluding a cross-linking agent and a foaming agent, the prototype being sole-shaped; and
(b) using a supercritical fluid to foam the prototype so as to directly get the thermoplastic polymer foaming sole;
wherein a density of the thermoplastic polymer foaming sole is larger than or equal to 0.3 g/cm³ and smaller than or equal to 0.8 g/cm³.

2. The method of claim 1, wherein the thermoplastic polymer foaming is amplified in proportion to the prototype.

3. The method of claim 1, wherein a thickness of the prototype is larger than or equal to 2 mm and smaller than or equal to 8 mm.

4. The method of claim 1, wherein the supercritical fluid is carbon oxide, water, methane, ethane, ethylene, propylene, methanol, ethanol, acetone or nitrogen.

5. The method of claim 1, wherein a temperature for foaming the prototype in step (b) is larger than or equal to 95° C. and smaller than or equal to 180° C.

6. The method of claim 1, wherein a pressure of the supercritical fluid is larger than or equal to 1000 psi and smaller than or equal to 3000 psi.

7. The method of claim 1, wherein the prototype in step (a) is form by an injection molding process, an extrusion process, a hot pressing process or casting mold process.

8. A method for manufacturing a thermoplastic polymer foaming sole, comprising:
(a) forming a liquid base material, the liquid base material comprising thermoplastic polyurethane or thermoplastic polyester elastomer;
(b) infusing the liquid base material into a shaping mold so as to form the liquid base material into a prototype;
(c) disposing the prototype in a foaming mold;
(d) introducing a supercritical fluid in the foaming mold to allow the supercritical fluid to penetrate into the prototype; and
(e) depressurizing the foaming mold to allow the prototype to foam into the thermoplastic polymer foaming sole;
wherein a density of the thermoplastic polymer foaming sole is larger than or equal to 0.3 g/cm³ and smaller than or equal to 0.8 g/cm³.

9. The method of claim 8, wherein the thermoplastic polymer foaming sole is amplified in proportion to the prototype.

10. The method of claim 8, wherein a temperature for foaming the prototype in step (d) is larger than or equal to 95° C. and smaller than or equal to 180° C.

11. The method of claim 8, wherein a pressure of the supercritical fluid in step (d) is larger than or equal to 1000 psi and smaller than or equal to 3000 psi.

12. A thermoplastic polymer foaming midsole manufactured by the method of claim 1, wherein a density of the thermoplastic polymer foaming midsole is larger than or equal to 0.3 g/cm³ and smaller than or equal to 0.45 g/cm³.

13. A thermoplastic polymer foaming outsole manufactured by the method of claim 1, wherein a density of the thermoplastic polymer foaming outsole is larger than or equal to 0.45 g/cm³ and smaller than or equal to 0.8 g/cm³.
